(19) United States
(12) Patent Application Publication
(10) Pub. No.: US 2025/0056100 A1
(43) Pub. Date: Feb. 13, 2025

(54) MULTIMEDIA DATA PROCESSING DEVICE AND MULTIMEDIA DATA PROCESSING METHOD

(71) Applicant: SigmaStar Technology Ltd., Xiamen (CN)

(72) Inventors: Wenshuai XI, Shenzhen (CN); Chao WANG, Shenzhen (CN)

(21) Appl. No.: 18/791,806

(22) Filed: Aug. 1, 2024

(30) Foreign Application Priority Data
Aug. 11, 2023 (CN) 202311013055.1

(51) Int. Cl. H04N 21/6402; H04N 21/85

(52) U.S. Cl. CPC H04N 21/6402; H04N 21/85

(57) ABSTRACT

A multimedia data processing method includes operations of: configuring, by a processor, a data transmission relationship among multimedia processing circuits; allocating, by the processor, a first space of a memory to a first circuit among the multimedia processing circuits; transmitting, by the processor, first address information of the first space in the memory to a second circuit among the multimedia processing circuits in a kernel space; generating, by the first circuit, first data according to multimedia data, and storing the first data to the first space; and obtaining, by the second circuit, the first data in response to the first address information and processing the first data to generate output data.

This application claims the benefit of China application Serial No. CN202311013055.1, filed on Aug. 11, 2023, the subject matter of which is incorporated herein by reference.

### BACKGROUND OF THE INVENTION

### Field of the Invention

The present application relates to a multimedia data processing device, and more particularly to a multimedia data processing device and method capable of improving data transmission efficiency.

### Description of the Related Art

In an image data processing device implemented based on a Linux system, multiple applications in a user space need to issue multiple systems calls to a kernel space to exchange data, and transmit the data to corresponding processing circuits for processing. In other words, in the image data processing device above, the transmission between the image data and multiple processing circuits need to involve complex and numerous interactions (that is, the system calls) between multiple applications and the system kernel, resulting in degraded data transmission efficiency and increased latency time in image processing.

### SUMMARY OF THE INVENTION

In some embodiments, it is an object of the present application to provide a multimedia data processing device and a multimedia data processing method capable of enhancing data transmission efficiency so as to improve the drawbacks of the prior art.

In some embodiments, the multimedia data processing device includes a plurality of multimedia processing circuits and a processor. The plurality of multimedia processing circuits process multimedia data to generate output data. The processor configures a data transmission relationship among the multimedia processing circuits, and allocates a first space of a memory to a first circuit among the multimedia processing circuits. The first circuit generates first data based on the multimedia data, and stores the first data to the first memory. The processor transmits, according to the data transmission relationship, first address information of the first space in the memory to a second circuit among the multimedia processing circuits, and the second circuit obtains the first data from the first space according to the first address information and processes the first data to generate the output data.

In some embodiments, the multimedia data processing method includes operations of: configuring, by a processor, a data transmission relationship among multimedia processing circuits; allocating, by the processor, a first space of a memory to a first circuit among the multimedia processing circuits; transmitting, by the processor, first address information of the first space in the memory to a second circuit among the multimedia processing circuits in a kernel space according to the data transmission relationship; generating, by the first circuit, first data based on multimedia data, and storing the first data to the first space; and obtaining, by the second circuit, the first data according to the first address information and processing the first data to generate output data.

Features, implementations and effects of the present application are described in detail in preferred embodiments with the accompanying drawings below.

### BRIEF DESCRIPTION OF THE DRAWINGS

To better describe the technical solution of the embodiments of the present application, drawings involved in the description of the embodiments are introduced below. It is apparent that, the drawings in the description below represent merely some embodiments of the present application, and other drawings apart from these drawings may also be obtained by a person skilled in the art without involving inventive skills.

FIG. 1 is a schematic diagram of a multimedia data processing device according to some embodiments of the present application;

FIG. 2A is a schematic diagram of data transmission of the multimedia data processing device in FIG. 1 according to some embodiments of the present application;

FIG. 2B is a flowchart of the data transmission in FIG. 2A performed by the multimedia data processing device in FIG. 1 according to some embodiments of the present application;

FIG. 3 is a schematic diagram of software architecture of the multimedia data processing device in FIG. 1 according to some embodiments of the present application; and

FIG. 4 is a flowchart of a multimedia data processing method according to some embodiments of the present application.

### DETAILED DESCRIPTION OF THE INVENTION

All terms used in the literature have commonly recognized meanings. Definitions of the terms in commonly used dictionaries and examples discussed in the disclosure of the present application are merely exemplary, and are not to be construed as limitations to the scope or the meanings of the present application. Similarly, the present application is not limited to the embodiments enumerated in the description of the application.

The term “coupled” or “connected” used in the literature refers to two or multiple elements being directly and physically or electrically in contact with each other, or indirectly and physically or electrically in contact with each other, and may also refer to two or more elements operating or acting with each other. As given in the literature, the term “circuit” may be a device connected by at least one transistor and/or at least one active element by a predetermined means so as to process signals.

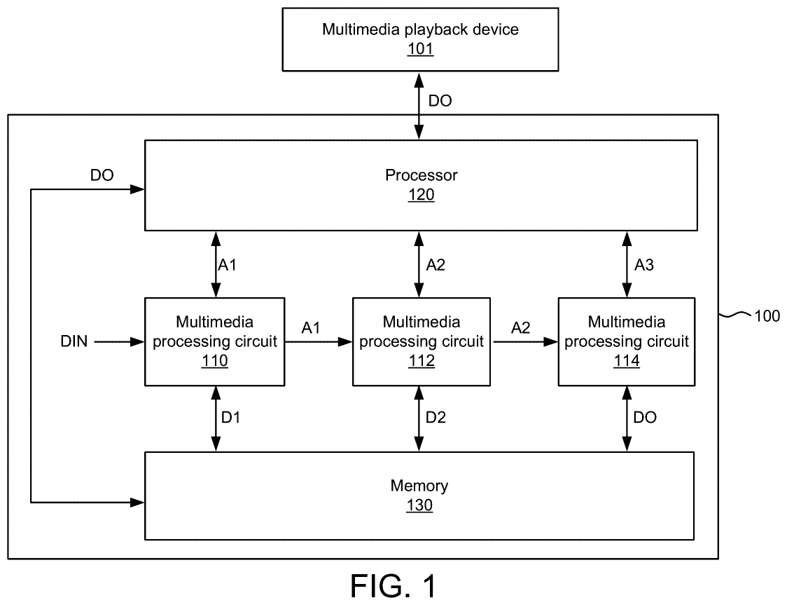

FIG. 1 shows a schematic diagram of a multimedia data processing device 100 according to some embodiments of the present application. In some embodiments, the multimedia data processing device 100 may be implemented by, for example but not limited to, a Linux system.

The multimedia data processing device 100 includes multiple multimedia processing circuits 110, 112 and 114, a processor 120 and a memory 130. In some embodiments, the multiple multimedia processing circuits 110, 112 and 114 can process multimedia data DIN to generate output data DO. In response to a request or a command of an application, the processor 120 can configure a data transmission relationship among the multiple multimedia processing circuits 110, 112 and 114, so that the multiple multimedia processing circuits 110, 112 and 114 can process the multimedia data DIN according to a predetermined sequence. For example, the multimedia data DIN is image data, and the application requests the multiple multimedia processing circuits 110, 112 and 114 to sequentially process the multimedia data DIN to generate the output data DO. In other words, a data processing sequence requested by the application is, the multimedia processing circuit 110, followed by the multimedia processing circuit 112, and then followed by the multimedia processing circuit 114. Thus, the corresponding data transmission relationship is that, the multimedia processing circuit 110 receives the multimedia data DIN and provides its output to the multimedia processing circuit 112, and an output of the multimedia processing circuit 112 is to be provided to the multimedia processing circuit 114. In this case, the multimedia processing circuit 110 can receive the multimedia data DIN from a sensor (for example but not limited to, a camera), and generate data D1 according to the multimedia data DIN. The multimedia processing circuit 112 can generate data D2 based on the data D1. The multimedia processing circuit 114 can generate the output data DO based on the data D2. In some embodiments, the processor 120 may be, for example but not limited to, a central processor. In some embodiments, the memory 130 may be, for example but not limited to, a random access memory.

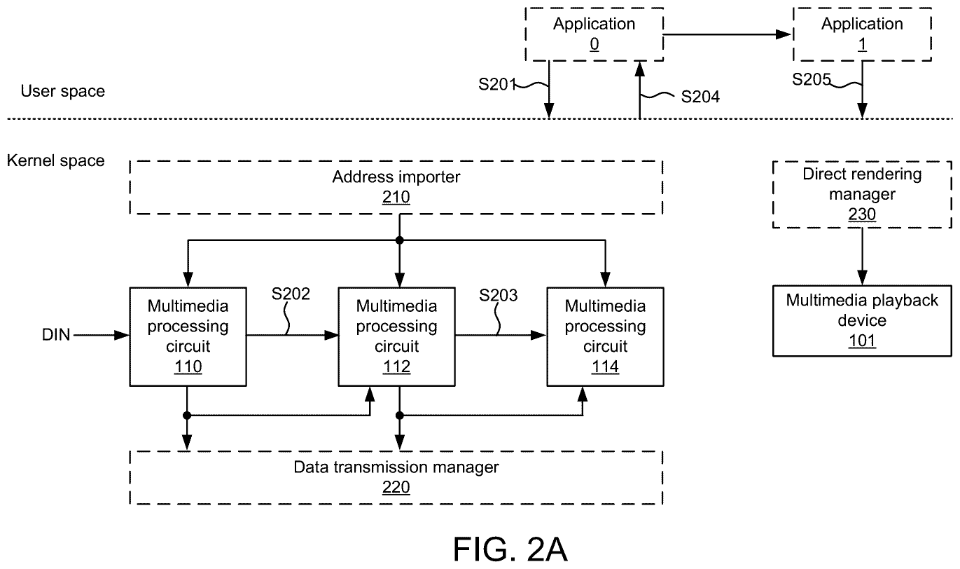

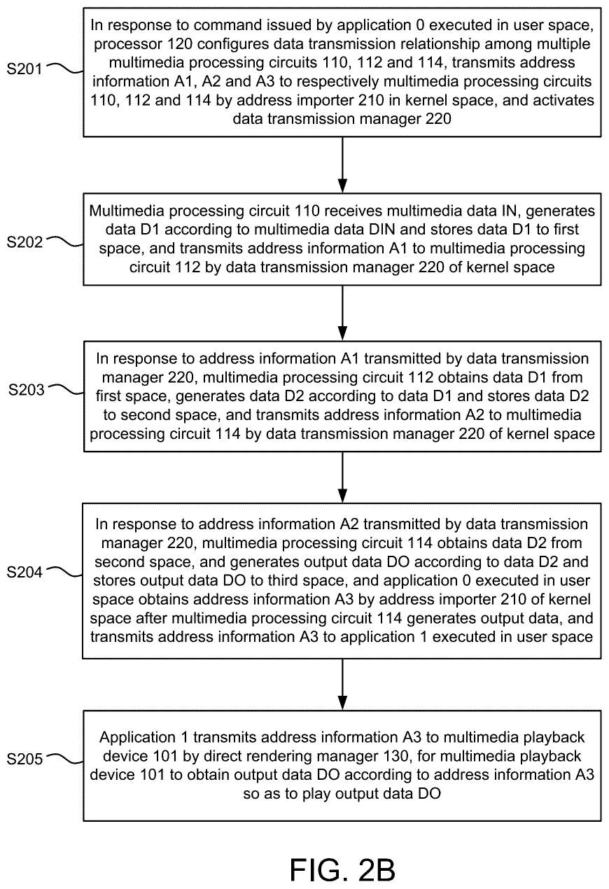

In some embodiments, in response to the request or command of the application above, the processor can allocate a first space (not shown) in the memory 130 to the multimedia processing circuit 110, allocate a second space (not shown) of the memory 130 to the multimedia processing circuit 112, and allocate a third space (not shown) in the memory 130 to the multimedia processing circuit 114. For example, the processor 120 can execute an address importer 210 in FIG. 2A, and accordingly transmit address information A1 of the first space in the memory 130 to the multimedia processing circuit 110 in a kernel space to be described shortly, such that the multimedia processing circuit 110 can generate the data D1 and then store the data D1 to the first space according to the address information A1. The processor 120 can transmit address information A2 of the second space in the memory 130 to the multimedia processing circuit 112 by the address importer 210 in the kernel space, such that the multimedia processing circuit 112 can generate the data D2 and then store the data D2 to the second space according to the address information A2. Similarly, the processor 120 can transmit address information A3 of the third space in the memory 130 to the multimedia processing circuit 114 by the address importer 210 in the kernel space, such that the multimedia processing circuit 114 can generate the output data DO and then store the output data DO to the third space according to the address information A3.

As described above, the processor 120 can configure the data transmission relationship among the multiple multimedia processing circuits 110, 112 and 114. According to the data transmission relationship, the multimedia processing circuit 110 can transmit the address information A1 to the multimedia processing circuit 112 by the processor 120 (for example, a data transmission manager 220 in FIG. 2A, executed by the processor 120), and the multimedia processing circuit 112 can transmit the address information A2 to the multimedia processing circuit 114 by the processor 120. Thus, after the multimedia processing circuit 110 generates the data D1, the multimedia processing circuit 112 can obtain the data D1 from the first space according to the address information A1, and generate the data D2 based on the data D1. Similarly, after the multimedia processing circuit 112 generates the data D2, the multimedia processing circuit 114 can obtain the data D2 from the second space according to the address information A2, and generate the output data DO based on the data D2. In other words, according to the data transmission relationship, the multiple multimedia processing circuits 110, 112 and 114 can directly obtain the required data without transferring to duplicating data to other spaces. Thus, data transmission efficiency can be enhanced. In some embodiments, the processor 120 can operate in privileged mode (for example, the kernel space to be described shortly) to configure or control operations of an output buffer (for example, an enqueue to be described shortly) and an output buffer (for example, a dequeue to be described shortly) of each of the multiple multimedia processing circuits 110, 112 and 114, to thereby establish the data transmission relationship among the multiple multimedia processing circuits 110, 112 and 114.

In some embodiments, in response to the request or command of the application above, the processor 120 can configure operation parameters and/or attributes of each of the multiple multimedia processing circuits 110, 112 and 114. For example, if the multimedia data DIN is image data, the multiple multimedia processing circuits 110, 112 and 114 may sequentially be, for example but not limited to, a video input circuit, an image signal processor (ISP) and a scaler. In this case, the processor 120 can configure data parameters (or attributes) that each of the multiple multimedia processing circuits 110, 112 and 114 uses to process image data, for example, the resolution, pixel format, crop range and rotation angle of the image data. In some embodiments, after the processor 120 configures the data parameters above, the multiple multimedia processing circuits 110, 112 and 114 can transmit the data parameters and the address information A1 and A2 by the processor 120 in the kernel space.

In some embodiments, the multimedia processing circuit 114 is the last circuit among the multiple multimedia processing circuits 110, 112 and 114, and the third space may be a direct memory access buffer (dma-buf) space in a Linux system. After the multimedia processing circuit 114 generates the output data DO, the multimedia processing circuit 114 can store the output data DO to the third space, and transmit the address information A3 corresponding to the third space to the processor 120 by the address importer 210. The processor 120 can obtain the output data DO from the third space (for example, the dma-buf space) according to the address information A3, and execute a corresponding application to play the output data DO. For example, if the multimedia data DIN is image data or video data, the processor 120 can perform a playback program (or a process of a playback program) after obtaining the output data, and transmit information of the dma-buf space by a direct rendering manager (DRM) in a Linux system to a multimedia playback device 101 (for example but not limited to, a display device), for the playback device 101 to obtain the output data DO from the third space according to the information of the dma-buf space and display contents corresponding to the output data DO.

In some embodiments, the operations above are primarily implemented by the processor 120 by means of executing predetermined software algorithms and/or operations to control data streams of the multiple multimedia processing circuits 110, 112 and 114. For better understanding, an operation relationship between the multiple operations performed by the processor 120 and other circuits is described following from a software perspective.

FIG. 2A shows a schematic diagram of data transmission of the multimedia data processing device 100 in FIG. 1 according to some embodiments of the present application. FIG. 2B shows a flowchart of the data transmission in FIG. 2A performed by the multimedia data processing device 100 in FIG. 1 according to some embodiments of the present application. For better illustration, in the example in FIG. 2A, the multimedia data DIN may be image data, and the multiple multimedia processing circuits 110, 112 and 114 may sequentially be a video input circuit, a DSP and a scaler respectively configured to perform operations including receiving image data, image processing and scaling control. In FIG. 2A, the blocks indicated by dotted lines are all function (and/or circuit) modules operated by the processor 120 in FIG. 1.

Referring to both FIG. 2A and FIG. 2B, as described above, the multimedia data processing device 100 may be implemented by, for example but not limited to, a Linux system. For example, system memory management of the processor 120 may be divided into a kernel space and a user space. The kernel space may be used to operate a system kernel, and is capable of directly accessing hardware resources (for example but not limited to, the multiple multimedia processing circuits 110, 112 and 114 and the memory 130 in FIG. 1). The user space may be used to run applications and processes, and is capable of accessing hardware resources by the system. In this example, in the kernel space, functions performed by the processor 120 include an address importer 210, a data transmission manager 220 and a direct rendering manager (DRM) 230, with associated details to be described shortly.

In operation S201, in response to a command issued by an application (or a user process) 0 executed in the user space, the processor 120 configures the data transmission relationship among the multiple multimedia processing circuits 110, 112 and 114, transmits the address information A1, A2 and A3 to the multimedia processing circuits 110, 112 and 114 by the address importer 210 of the kernel space, respectively, and activates the data transmission manager 220. In some embodiments, the processor 120 performs a subsequent operation after the address importer 210 finishes configuring the address information A3 of a last-stage circuit (for example, the multimedia processing circuit 114).

In operation S202, the multimedia processing circuit 110 receives the multimedia data DIN (for example but not limited to, image data of a frame), generates the data D1 based on the multimedia data DIN and stores the data D1 to the first space, and transmits the address information A1 to the multimedia processing circuit 112 by the data transmission manager 220 of the kernel space.

In operation S203, according to the address information A1 transmitted by the data transmission manager 220, the multimedia processing circuit 112 obtains the data D1 from the first space, generates the data D2 based on the data D1 and stores the data D2 to the second space, and transmits the address information A2 to the multimedia processing circuit 114 by the data transmission manager 220 of the kernel space.

In operation S204, according to the address information A2 transmitted by the data transmission manager 220, the multimedia processing circuit 114 obtains the data D2 from the second space, generates the output data DO based on the data D2 and stores the output data DO to the third space. Moreover, after generating the output data DO, the multimedia processing circuit 114 executes the application 0, obtains the address information A3 (which may be address information of the dma-buf space) by the address importer 210 of the kernel space, and transmits the address information A3 to the application (or user process) 1 executed in the user space.

In operation S205, the application 1 (executed by the processor 120) transmits the address information A3 to the multimedia playback device 101 by the direct rendering manager 203, for the multimedia playback device 101 to obtain the output data DO according to the address information A3 so as to play the output data DO (for example, displaying contents of the image data of a frame above).

In some related techniques, in order to perform a series of processes on multimedia data, a program needs to initiate multiple system calls to request a processor to call corresponding hardware resources. For example, in an original Linux system, a processor and an application calls the system by using a video for Linux 2 (V4L2) interface in the Linux system. For example, a first application operated in the user space configures a first multimedia processing circuit by the V4L2 interface, and after the first multimedia processing circuit generates data, the first application transmits, by the V4L2 interface, first DMA buffer information (which indicates a position of the data generated by the first multimedia processing circuit) to a second application operated in the user space. The second application can interact with a second multimedia processing circuit on the basis of the same operations above. Similarly, multiple subsequent applications and corresponding multimedia processing circuits can interact according to the operations above, until a multimedia playback device finishes playing corresponding multimedia contents. In the related techniques above, if the multimedia data DIN is to be processed three times, the application operated in the user space at least needs to initiate system calls six times and allocate the DMA buffer three times. Thus, more latency time is introduced into data transmission, and the overall system performance is undesirably affected.

Compared to the related techniques above, in the multiple operations shown in FIG. 2A and FIG. 2B, the application 0 and the application 1 operated in the user space only issue system calls three times (equivalent to interacting three times with the kernel space) and allocate the DMA buffer once. Moreover, the data transmission among the multiple multimedia processing circuits 110, 112 and 114 is handled by the data transmission manager 220 in the kernel space, and does not involve any participation of the application 0 and the application 1 in the user space. In other words, the data transmission relationship among the multiple multimedia processing circuits 110, 112 and 114 is established in the kernel space, and the multiple applications 0 and 1 are operated in the user space. Thus, the number of system calls issued by the applications 0 and 1 in the user space can be reduced, and the time and overhead used for data transmission are lowered, thereby improving data transmission efficiency. In other words, by configuring the data transmission relationship and sharing related address information of the memory in an environment of the kernel space, the number of interactions (that is, system calls) between the applications 0 and 1 in the user space and the kernel space of the system can be reduced, so that a computer function and/or a function of multimedia data processing of the multimedia data processing device 100 can be enhanced to thereby improve data transmission efficiency.

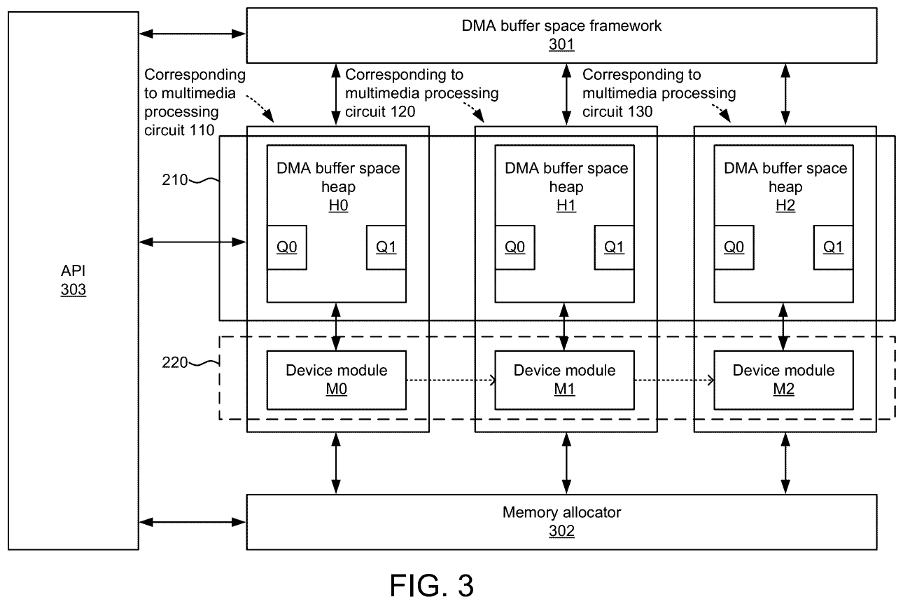

FIG. 3 shows a schematic diagram of software architecture of the multimedia data processing device 100 in FIG. 1 according to some embodiments of the present application. Different from FIG. 1, FIG. 3 primarily depicts related operations of the processor 120 from a software perspective. As described above, the functions performed by the processor 120 includes the address importer 210 and the data transmission manager 220 in FIG. 2A. In some embodiments, the address importer 210 is configured to manage interactions between a DMA buffer (dma-buf) heap that an application operated in a user space allocates for a driver of predetermined hardware resources (for example, the multiple multimedia processing circuits 110, 112 and 114) and a dma-buf framework 301 of the Linux system. For example, the processor 120 can interact with other devices (for example, the multimedia playback device 101) by the dma-buf framework 301. The address importer 210 can manage an enqueue Q0 and a dequeue Q1 of dma-buf heaps H0, H1 and H2 respectively corresponding to the multiple multimedia processing circuits 110, 112 and 114. In some embodiments, the address importer 210 can convert address information of the dma-buf by the dma-buf framework 301 to memory information identifiable to a driver, and add the memory information to a list of enqueues or dequeues.

In some embodiments, the data transmission manager 220 is configured to manage interactions between data transmission and corresponding drivers, and can access the memory 130 in FIG. 1 by a memory allocator 302. Device modules M0, M1 and M2 respectively corresponding to the multimedia processing circuits 110, 112 and 114 can be allocated with multiple spaces of the memory 130 by the memory allocator 302, so that the multiple multimedia processing circuits 110, 112 and 114 are able to transmit information (for example but not limited to, data addresses and data attributes) to one another in the kernel space. Moreover, the address importer 210, the data transmission manager 220, the dma-buf framework 301 and the memory allocator 302 can interact with the applications in the user space by an application programming interface (API) 303.

In some embodiments, operations associated with the address importer 210 includes: in response to a command or a request from an application, the processor 120 allocating a dma-buf space (for example, the third space above) to the last circuit (for example, the multimedia processing circuit 114) among multiple multimedia processing circuits by the address importer 210, and destroying, by the address importer 210, a dma-buf space previously allocated; the processor 120 activating the enqueue Q0 of the dma-buf space by the address importer 210, and waiting for the multiple multimedia processing circuits to generate the output data DO; activating the dequeue Q1 of the dma-buf space, for the multimedia playback device 101 to obtain the output data; and the processor 120 discarding the dma-buf space by the address importer 210 after the multimedia playback device 101 plays the output data DO.

In some embodiments, operations associated with the data transmission manager 220 includes: the device modules M0 to M2 corresponding to the multiple multimedia processing circuits registering to the data transmission manager 220, for the data transmission manager 220 to be able to process the enqueue Q0 and the dequeue Q1 associated with the device modules M0 to M2; the data transmission manager 220 establishing a data transmission relationship (for example, assigning an output (for example, the data D1) of the device module M0 to be an input to the device module M1, and assigning an output (for example, the data D2) of the device module M1 to be an input to the device module M2) among the multiple device modules M0 to M2; the data transmission manager 220 controlling the enqueue Q0 and the dequeue Q1 associated with the device modules M0 to M2 according to the data transmission relationship, until the output data DO is completely generated; and releasing the data transmission relationship among the multiple device modules M0 to M2.

In some embodiments, each of the multiple device modules M0 to M2 and/or the dma-buf heaps H0 to H2 has a corresponding module identifier, and the processor 120 can use the module identifier to perform the multiple operations described above by different APIs in response control or requests of an application. In some embodiments, the API above can be designed with corresponding function relations and basic functions according to actual requirements, and such details are omitted herein.

In the disclosure above, image data is taken as an example of the multimedia data DIN in the description; however, the present application is not limited to such example. In different embodiments, the multimedia data DIN may be different types of data, and the multiple multimedia processing circuits 110, 112 and 114 may also be related processing circuits processing the corresponding types of data. Moreover, the number of the multiple multimedia processing circuits 110, 112 and 114 is merely an example in the present application, and the present application is not limited to such example. According to different application requirements, the number of the multimedia processing circuits can be correspondingly adjusted.

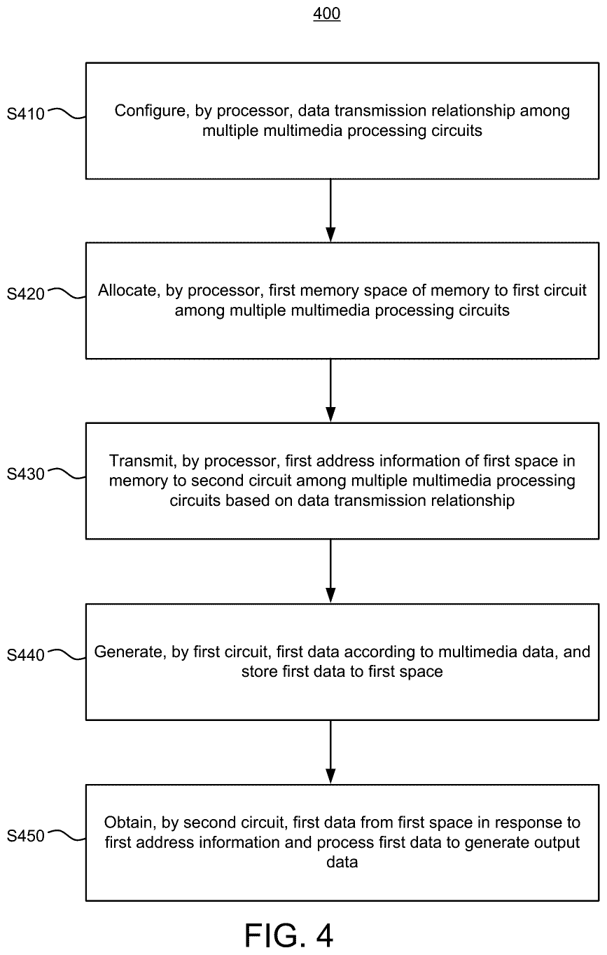

FIG. 4 shows a flowchart of a multimedia data processing method 400 according to some embodiments of the present application. In some embodiments, the data processing method 400 may be performed by, for example but not limited to, the multimedia data processing device 100 in FIG. 1.

In operation S410, a data transmission relationship among multiple multimedia processing circuits is configured by a processor. In operation S420, a first space of a memory is allocated to a first circuit among the multiple multimedia processing circuits by the processor. In operation S430, first address information of the first space in the memory is transmitted to a second circuit among the multiple multimedia processing circuits by the processor in a kernel space according to the data transmission relationship. In operation S440, first data is generated based on the multimedia data, and the first data is stored to the first space by the first circuit. In operation S450, according to the first address information, the first data is obtained from the first space and is processed by the second circuit to generate output data.

Details associated with the multiple operations of the multimedia data processing method 400 above can be referred from the details of the embodiments above, and are omitted herein. The plurality operations of the multimedia data processing method 400 above are merely examples, and are not limited to being performed in the order specified in this example. Without departing from the operation means and ranges of the various embodiments of the present application, additions, replacements, substitutions or omissions may be made to the operations of the multimedia data processing method 400, or the operations may be performed in different orders (for example, entirely simultaneously performed or partially simultaneously performed).

In conclusion, the multimedia data processing device and method according to some embodiments of the present application are capable of reducing the number of system calls made by an application, and configure a data transmission relationship among multiple circuits to thereby improve the overall data transmission efficiency.

While the present application has been described by way of example and in terms of the preferred embodiments, it is to be understood that the disclosure is not limited thereto. Various modifications made be made to the technical features of the present application by a person skilled in the art on the basis of the explicit or implicit disclosures of the present application. The scope of the appended claims of the present application therefore should be accorded with the broadest interpretation so as to encompass all such modifications.

What is claimed is:

1. A multimedia data processing device, comprising:
a plurality of multimedia processing circuits, processing multimedia data to generate output data; and
a processor, configuring a data transmission relationship among the processing circuits, and allocating a first space of a memory to a first circuit among the multimedia processing circuits,
wherein, the first circuit generates first data based on the multimedia data and stores the first data to the first space, the processor transmits, according to the data transmission relationship, first address information of the first space in the memory to a second circuit among the multimedia processing circuits, and the second circuit obtains the first data from the first space according to the first address information and processes the first data to generate the output data.

2. The multimedia data processing device according to claim 1, wherein the processor further allocates a second space of the memory to the second circuit, and the second circuit generates second data based on the first data and stores the second data to the second space.

3. The multimedia data processing device according to claim 2, wherein the first circuit is a video input circuit, the second circuit is an image signal processor (ISP), and a last circuit among the multimedia data processing circuits is a scaler.

4. The multimedia data processing device according to claim 2, wherein the processor transmits, according to the data transmission relationship, second address information of the second space in the memory to a last circuit among the multimedia processing circuits, and the last circuit obtains the second data from the second space according to the second address information and processes the second data to generate the output data.

5. The multimedia data processing device according to claim 1, wherein the processor further allocates a direct memory access (DMA) buffer to a last circuit among the multimedia data processing circuits, the last circuit stores the output data to the DMA buffer, and the processor obtains the output data from the DMA buffer and executes an application so as to play the output data.

6. The multimedia data processing device according to claim 5, wherein the processor executes the application to transmit address information of the DMA buffer to a multimedia playback device by a direct rendering manager, for the multimedia playback device to obtain the output data.

7. A multimedia data processing method, comprising:
configuring, by a processor, a data transmission relationship among a plurality of multimedia processing circuits;
allocating, by the processor, a first space of a memory to a first circuit among the multimedia processing circuits;
transmitting, by the processor, first address information of the first space in the memory to a second circuit among the multimedia processing circuits in a kernel space according to the data transmission relationship;
generating, by the first circuit, first data based on multimedia data, and storing the first data to the first space; and
obtaining, by the second circuit, according to the first address information, the first data from the first space and processing, by the second circuit, the first data to generate output data.

8. The multimedia data processing method according to claim 7, further comprising:
allocating, by the processor, a DMA buffer to a last circuit among the processing circuits;
storing, by the last circuit, the output data to the DMA buffer; and
obtaining, by the processor, the output data from the DMA buffer, and executing, by the processor, an application to play the output data.

9. The multimedia data processing method according to claim 8, wherein the obtaining, by the processor, the output data from the DMA buffer, and executing, by the processor, an application to play the output data comprises:
executing, by the processor, the application to transmit address information of the DMA buffer to a multimedia playback device by a direct rendering manager, for the multimedia playback device to obtain the output data.

10. The multimedia data processing method according to claim 7, wherein the obtaining, by the second circuit according to the first address information, the first data from the first space and processing the first data to generate output data comprises:
allocating, by the processor, a second space of the memory to a second circuit among the multimedia processing circuits;
generating, by the second circuit, second data based on the first data, and storing the second data to the second space;
transmitting, by the processor, second address information of the second space in the memory to a last circuit among the multimedia processing circuits in the kernel space according to the data transmission relationship; and
obtaining, by the last circuit according to the second address information, the second data from the second space and processing the second data to generate the output data.
